(19) United States
(12) Patent Application Publication
(10) Pub. No.: US 2026/0051999 A1
(43) Pub. Date: Feb. 19, 2026

(54) SUBTHZ/SCELL UL SYNCHRONIZATION BASED ON PCELL TA

(71) Applicant: QUALCOMM Incorporated, San Diego, CA (US)

(72) Inventors: Daniel PAZ, Atlit (IL); Michael LEVITSKY, Rehovot (IL); Assaf TOUBOUL, Netanya (IL)

(21) Appl. No.: 19/101,572

(22) PCT Filed: Sep. 8, 2023
(86) PCT No.: PCT/US2023/032356

§ 371 Date: Feb. 5, 2025

(30) Foreign Application Priority Data
Sep. 23, 2022 (IL) 296796

(51) Int. Cl. H04L 5/00; H04W 36/00

(52) U.S. Cl. CPC H04L 5/0098; H04W 36/0072

(57) ABSTRACT

A method of wireless communication at a UE is disclosed herein. The method includes obtaining an indication of a first TA for a PCell, where the PCell is associated with a first frequency band. The method includes estimating a timing offset between the PCell and a SCell. The method includes deriving a second TA for the SCell based on the first TA and the timing offset, where the SCell is associated with a second frequency band that is greater than the first frequency band. The method includes transmitting, for a network node, data or at least one signal via the SCell based on the second TA.

### CROSS-REFERENCE TO RELATED APPLICATION

This application claims the benefit of Israel Patent Application Serial No. 296796, entitled “SUBTHZ/SCELL UL SYNCHRONIZATION BASED ON PCELL TA” and filed on Sep. 23, 2022, which is expressly incorporated by reference herein in its entirety.

### TECHNICAL FIELD

The present disclosure relates generally to communication systems, and more particularly, to timing advances (TAs).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus for wireless communication at a user equipment (UE) are provided. The apparatus includes a memory and at least one processor coupled to the memory and, based at least in part on information stored in the memory, the at least one processor is configured to: obtain an indication of a first timing advance (TA) for a primary cell (PCell), where the PCell is associated with a first frequency band; estimate a timing offset between the PCell and a secondary cell (SCell); derive a second TA for the SCell based on the first TA and the timing offset, where the SCell is associated with a second frequency band that is greater than the first frequency band; and transmit, for a network node, data or at least one signal via the SCell based on the second TA.

In an aspect of the disclosure, a method, a computer-readable medium, and an apparatus for wireless communication at a network node are provided. The apparatus includes a memory and at least one processor coupled to the memory and, based at least in part on information stored in the memory, the at least one processor is configured to: transmit, for a user equipment (UE), an indication of a first timing advance (TA) for a primary cell (PCell), where the PCell is associated with a first frequency band; and receive data or at least one signal via a secondary cell (SCell) based on a second TA, where the second TA is based on the first TA and a timing offset between the PCell and the SCell, where the SCell is associated with a second frequency band that is greater than the first frequency band.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a sub-terahertz (subTHz) wireless communication network.

FIG. 5 is a diagram illustrating an example of estimating a timing offset.

FIG. 6 is a diagram illustrating an example of deriving a TA.

FIG. 7 is a diagram illustrating an example communications flow between a UE and a base station.

FIG. 8 is a flowchart of a method of wireless communication.

FIG. 9 is a flowchart of a method of wireless communication.

FIG. 10 is a flowchart of a method of wireless communication.

FIG. 11 is a flowchart of a method of wireless communication.

FIG. 12 is a diagram illustrating an example of a hardware implementation for an example apparatus and/or network entity.

FIG. 13 is a diagram illustrating an example of a hardware implementation for an example network entity.

### DETAILED DESCRIPTION

A wireless communication system may allow for transmission and reception of data over a sub-terahertz (subTHz) frequency band. The subTHz frequency band may allow for faster data rates in comparison to other frequency bands (e.g., FR1, FR2, FR4). However, in comparison to wireless communications systems using non-subTHz frequencies, a wireless communication system that utilizes subTHz frequencies may have limited coverage and/or higher power specifications. A UE within a subTHz deployment may be connected to a PCell associated with FR1/FR2/FR4 and an SCell associated with a subTHz frequency. In order to transmit data/signals over the SCell/subTHz, a UE may obtain a TA. Obtaining a TA via a RACH procedure with the SCell/subTHz may be time consuming and may be associated with increased latency and/or increased power consumption at the UE. Various technologies pertaining to deriving a SCell/subTHz TA based on a PCell TA are described herein. In an example, a UE obtains an indication of a first TA for a PCell, where the PCell is associated with a first frequency band. The UE estimates a timing offset between the PCell and a SCell. The UE derives a second TA for the SCell based on the first TA and the timing offset, where the SCell is associated with a second frequency band that is greater than the first frequency band. The UE transmits, for a network node, data or at least one signal via the SCell based on the second TA. Via derivation of the second TA based on the first TA and the timing offset, the UE may be able to avoid performing a RACH procedure with the SCell/subTHz. Thus, the latency for transmission of data/signals via the SCell/subTHz may be lower in comparison to latency associated with a scenario in which the UE obtains the second TA via a RACH procedure. Furthermore, by avoiding performing the RACH procedure with the SCell/subTHz, the above-described technologies may be associated with lower power consumption by the UE and/or lower computational burdens on the UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can comprise a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

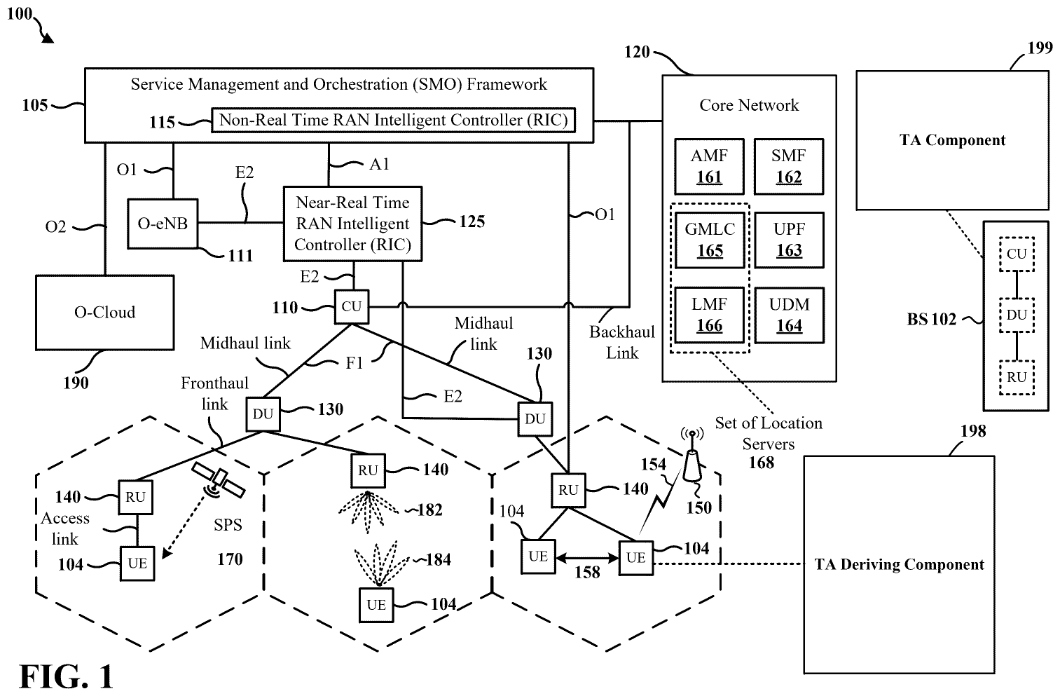

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base stations 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth, Wi-Fi based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a transmit reception point (TRP), network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the serving base station 102. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may be configured with a TA deriving component 198 that is configured to: obtain an indication of a first TA for a PCell, where the PCell is associated with a first frequency band; estimate a timing offset between the PCell and a SCell; derive a second TA for the SCell based on the first TA and the timing offset, where the SCell is associated with a second frequency band that is greater than the first frequency band; and transmit, for a network node, data or at least one signal via the SCell based on the second TA. In certain aspects, the base station 102 may be configured with a TA component 199 that is configured to: transmit, for a UE, an indication of a first TA for a PCell, where the PCell is associated with a first frequency band; and receive data or at least one signal via a SCell based on a second TA, where the second TA is based on the first TA and a timing offset between the PCell and the SCell, where the SCell is associated with a second frequency band that is greater than the first frequency band. Although the following description may be focused on deriving a subTHz TA based on a FR1/FR2/FR4 TA, the concepts described herein may applicable to deriving a TA for a SCell based on a TA for a PCell, where the PCell is associated with a first frequency band and the SCell is associated with a second frequency band, and where the second frequency band is greater than the first frequency band.

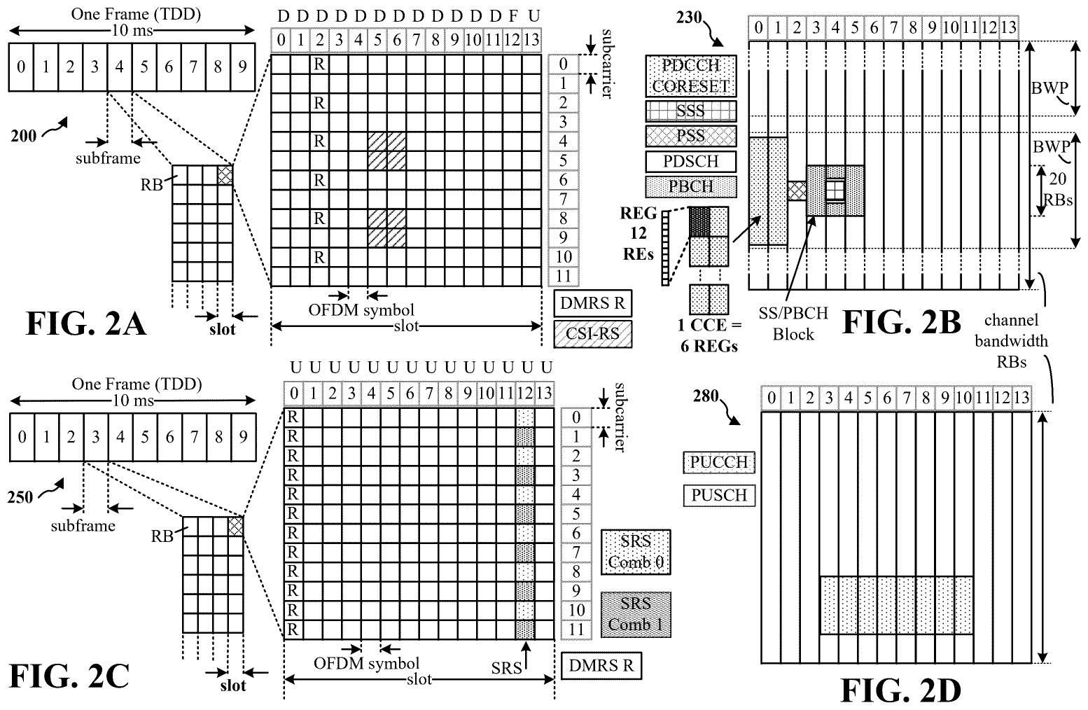

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15 [kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

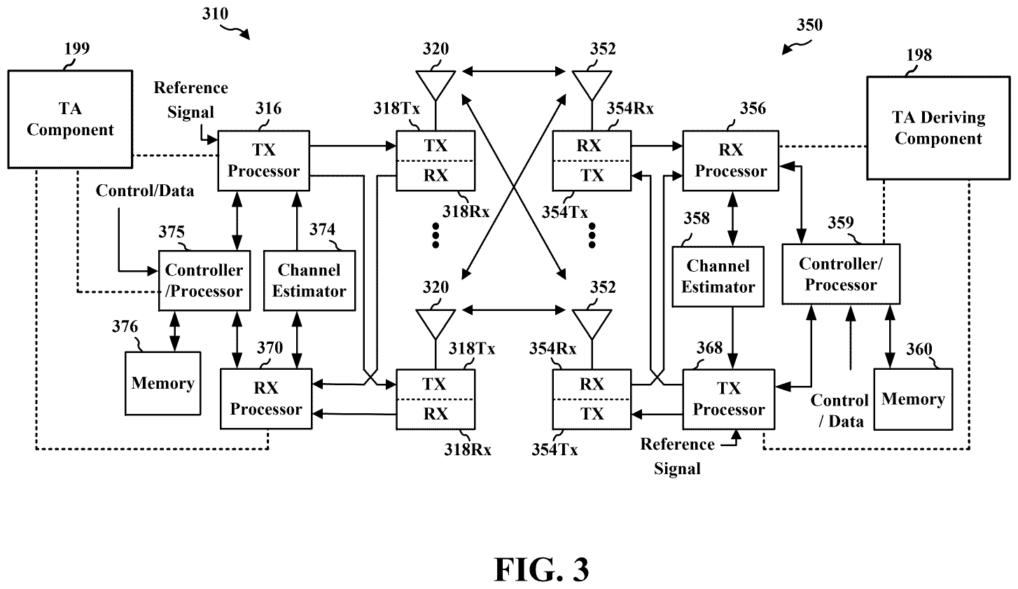

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the TA deriving component 198 of FIG. 1.

At least one of the TX processor 316, the RX processor 370, and the controller/processor 375 may be configured to perform aspects in connection with the TA component 199 of FIG. 1.

A wireless communication system may allow for transmission and reception of data over a subTHz frequency band. The term “subTHz frequency band” may refer to FR4 and/or FR5. The subTHz frequency band may allow for faster data rates in comparison to other frequency bands (e.g., FR1, FR2, FR4). However, a wireless communication system that utilizes subTHz frequencies may have limited coverage compared to a wireless communication system that utilizes other frequency bands. For instance, a subTHz wireless communication system may have limited maximum power amplifier (PA) output power characteristics compared to a mm-wave wireless communication system. For instance, the subTHz wireless communication system may have 10 dB less maximum PA output power than a mm-wave wireless communication system. Furthermore, a subTHz wireless communication system may utilize a higher signal bandwidth in comparison to a mm-wave wireless communication system which may result in an equivalent isotropically radiated power (EIRP) deficit for a subTHz which limits coverage of the subTHz wireless communication system. In an example, a subTHz wireless communication system may have two to three times less range than a mm-wave wireless communication system. A subTHz wireless communication system may have a reduction in PA efficiency by at least of factor of two (compared to a mm-wave wireless communication system) which may result in lower subTHz link power/energy efficiency. In an example, subTHz PA efficiency may range from 1-8% depending on a power backoff (BO). In an example, a PA may transmit at a power level. Input power to the PA may vary. A power BO may be configured with respect to the power level such that output of the PA is not saturated. Furthermore, to provide a fast target data rate, a subTHz wireless communication system may utilize a SCS that is eight times higher than a SCS for a mm-wave wireless communication system due to a higher signal bandwidth associated with subTHz wireless communications. In comparison to a mm-wave wireless communication system, a subTHz wireless communication system may have less efficient RF processing, a higher power consumption related to analog to digital (A2D) and digital to analog (D2A components having higher sampling rates (i.e., roughly linearly translated to consumed power), higher rate digital processing rates, higher bit rates addressed on a decoder side, and higher memory and storage related power consumption.

As a result of the aforementioned issues, a subTHz wireless communication system (i.e., a subTHz deployment) may be configured as follows. First, as noted above, subTHz may have limited coverage compared to other wireless communication systems. To address this issue, a subTHz wireless communication system may achieve broader coverage using other frequency bands (FR1/FR2/FR4) in addition to a subTHz frequency band. For instance, a subTHz wireless communication may be deployed in a non-standalone (NSA)/self-contained deployment. A subTHz deployment may target UEs that have relatively large data traffic specifications. Second, as noted above, a subTHz deployment may be less efficient from a power efficiency perspective compared to other wireless communication systems. To address this issue, a subTHz deployment may utilize lower frequency bands (e.g., FR1/FR2/FR4) for relatively small data transmissions and control related signaling and link maintenance procedures. This may be referred to as “traffic offloading.” Traffic offloading may be achieved via access points (APs) configured for subTHz communications that are placed in location that have a relatively high data volume demand potential. Third, due to power/battery specifications and relatively high data volumes target for subTHz links, a number of simultaneously active subTHz UEs in an area may be limited. To address this issue, an AP may provide a per demand high-capacity channel to subTHz eligible UEs that may be registered under a lower band/PCell. The per demand high-capacity channel may be referred to as a side band or as a supplementary high-capacity channel that has a burst activity pattern for sparse usage in time. SubTHz eligible UEs may be continuously subscribed/connected to a lower band/PCell.

As noted above, a UE within a subTHz deployment may be continuously connected to a PCell. A subTHz link may be dynamically activated for a time period in which a subTHz eligible UE may receive/transmit relatively large amounts of data to/from a base station in order to increase power efficiency. If a SCell/subTHz is activated for a UE, the UE may obtain a TA for the SCell/subTHz in order to transmit UL data for a base station via with/over the SCell/subTHz. A TA is a command send by a base station to a UE to adjust an UL transmission time such that reception timing on the base station side may be aligned with slot/symbol time boundaries according to a base station timeline. A UE may transmit UL symbols in advance according to a TA command that synchronizes UL timing per UE transmission (e.g., PUSCH transmissions, PUCCH transmissions, SRS transmissions). A timing advance command (TAC) may inform a UE as to an amount of time that the UE is to advance UL transmissions. A UE may obtain a subTHz TA during a RACH procedure; however, such a RACH procedure may be time consuming.

Various technologies pertaining to deriving a SCell/subTHz TA based on a PCell TA are described herein. In an example, a UE obtains an indication of a first TA for a PCell, where the PCell is associated with a first frequency band. The UE estimates a timing offset between the PCell and a SCell. A timing offset may refer to a difference between a timing grid of the PCell and a timing grid of the SCell which may be partially aligned (e.g., a transmission associated with the PCell may start at time T0, but from a perspective of the SCell, the transmission starts at T1 and as such the timing offset may be T1−T0). The UE derives a second TA for the SCell based on the first TA and the timing offset, where the SCell is associated with a second frequency band that is greater than the first frequency band. The UE transmits, for a network node, data or at least one signal via the SCell based on the second TA. Via derivation of the second TA based on the first TA and the timing offset, the UE may be able to avoid performing a RACH procedure with the SCell/subTHz. Thus, the latency for transmission of data/signals via the SCell/subTHz may be lower in comparison to latency associated with a scenario in which the UE obtains the second TA via a RACH procedure. Furthermore, by avoiding performing the RACH procedure with the SCell/subTHz, the above-described technologies may be associated with lower power consumption by the UE and/or lower computational burdens on the UE. Additionally, the above-described technologies may be utilized by different components in a multi-hop link (e.g., repeaters, access points, etc.) and hence may simplify TA determination in the multi-hop link.

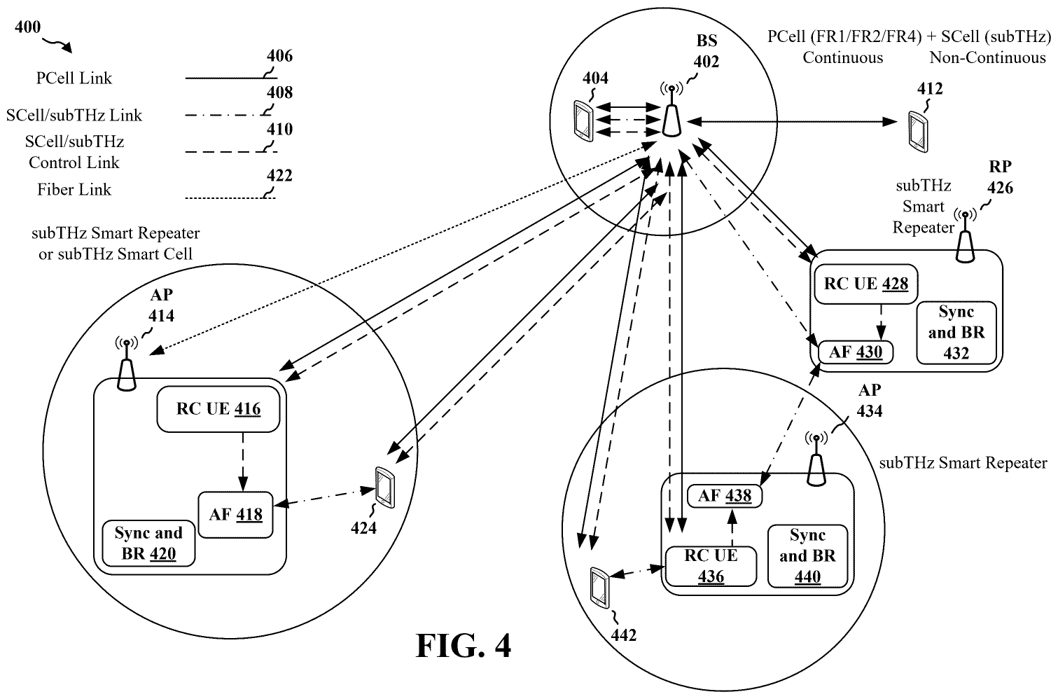

FIG. 4 is a diagram 400 illustrating an example of a subTHz wireless communication network. The subTHz wireless communication network may include a base station 402. The base station 402 may be configured to operate in a first frequency band (e.g., FR1/FR2/FR4) and a second frequency band (e.g., subTHz), where the second frequency band is greater than the first frequency band. Stated differently, the base station 402 may transmit and receive signals/data to/from UEs and/or repeaters via FR1/FR2/FR4 and/or subTHz frequency bands. In an example, the base station 402 may be associated with an inter band carrier aggregation (CA) configuration. In such a configuration, FR1/FR2/FR4 may be referred to as a “PCell” and the subTHz frequency band may be referred to as an “SCell.” The subTHz wireless communication network may be based on spot-based coverage with a range of the PCell. The SCell/subTHz may rely upon the PCell for control and/or scheduling. UEs may have a continuous connection to the PCell while having a non-continuous connection to the SCell/subTHz. For instance, the base station 402 may activate the SCell/subTHz for sporadic and typically short time sessions. Such sessions may be associated with a burst activity pattern. SCell/subTHz synchronization and beam management (BM) may be based on synchronization/BM characteristics of the PCell. For instance, there may be a “warm start” for each subTHz link activation. SCell/subTHz activations may be associated with relatively fast, low complexity, low power, and/or low latency synchronization and BM procedures.

The subTHz wireless communication network may include a UE 404. The UE 404 may include a first radio that is capable of transmitting/receiving data/signals via/with/over FR1/FR2/FR4 second radio that is capable of transmitting/receiving data/signals via/with/over a subTHz frequency band. Alternatively, the UE 404 may include a radio that is capable of transmitting/receiving data/signals via/with/over FR1/FR2/FR4 and the subTHz frequency band. The UE 404 may communicate with the base station 402 via/with/over a PCell link 406, where the PCell link 406 is associated with FR1/FR2/FR4. For subTHz data transmission/reception purposes, the UE 404 may also communicate with the base station 402 via/with/over a SCell/subTHz link 408. The SCell/subTHz link 408 may be associated with a subTHz frequency band. For subTHz control signaling purposes, the UE 404 may communicate with the base station 402 via/with/over a SCell/subTHz control link 410. The subTHz wireless communication network may also include a UE 412 that may communicate with the base station 402 via/with/over the PCell link 406. The UE 412 may not be configured with a radio that is capable of transmitting/receiving data/signals at the subTHz frequency band. Alternatively, the UE 412 may not meet criteria (described in greater detail below) for subTHz communication with the base station 402.

As noted above, communications at the subTHz frequency band may be range limited. SubTHz range limitations may be bridged via one or more repeaters (single or multiple hop), that is, the one or more repeaters may facilitate single or multiple hops between a subTHz UE and a subTHz transceiver of the base station 402. A repeater may enable a line of sight channel (LOS) between the base station 402 and UEs. A repeater may enable SubTHz communications to penetrate and/or bypass obstacles that impede a LOS channel. Furthermore, a repeater may extend an effective range of the base station 402. A repeater may receive a wireless signal from a base station and amplify and/or redirect the wireless signal. In an example, the repeater may transmit different beams in different directions at different points in time based upon the wireless signal. A UE may receive the wireless signal via one of the (redirected) different beams.

In an example, the subTHz wireless communication network may include an access point (AP) 414. The AP 414 may be referred to as a repeater, a smart repeater, or a subTHz smart repeater. The AP 414 may be associated with a subTHz smart cell. The AP 414 may be relatively power efficient and may utilize out-of-band (OOB) control signaling based on the PCell. The AP 414 may include a redcap (RC) UE 416 for PCell connectivity. The RC UE 416 may deliver OOB control/reporting/feedback. The AP 414 may include wideband (WB) amplification and forwarding (AF) functionality (referred to in the diagram 400 as “AF 418”) for subTHz data forwarding. The AP 414 may also include dedicated NB reference signal (RS) transmission (Tx)/reception (Rx) functionality (referred to in the diagram 400 as “sync and BR 420”) over the subTHz frequency band for complementary time synchronization and/or beam refinement (i.e., interband (IB) processing). The AP 414 may provide for progressive synchronization across hops between repeaters, hop specific synchronizations, and/or BM sessions with customized synchronization RS/SSB mini burst scheduling.

The AP 414 may communicate with the base station 402 via/with/over a fiber link 422. The AP 414 (e.g., through the RC UE 416) may communicate with the base station 402 via/with/over the PCell link 406 and the SCell/subTHz control link 410. The RC UE 416 may communicate with the AF 418 via/with/over the SCell/subTHz control link 410.

The subTHz wireless communication network may include a UE 424. The AP 414 and the UE 424 may have a direct connection (i.e., a service link). The UE 424 may communicate with the base station 402 via/with/over the PCell link 406 and the SCell/subTHz control link 410. The AF 418 and the UE 424 may communicate via/with/over the SCell/subTHz link 408.

The subTHz wireless communication network may include a repeater (RP) 426. The RP 426 may be referred to as a repeater, a smart repeater, or a subTHz smart repeater. The RP 426 may be relatively power efficient and may utilize OOB control signaling based on the PCell. The RP 426 may be configured with similar functionality as the AP 414. The RP 426 may have different hardware and/or capabilities than the AP 414. The RP 426 may have an intermediate or a direct link (i.e., a donor link) with the base station 402. The RP 426 may include a RC UE 428 for PCell connectivity. The RC UE 428 may be similar or identical to the RC UE 416 described above. The RP 426 may include AF 430 for subTHz data forwarding. The AF 430 may be similar to the AF 418 described above. The RP 426 may also include sync and BR 432 over the subTHz frequency band for complementary time synchronization and/or beam refinement. The sync and BR 432 may be similar or identical to the sync and BR 420 described above. The RP 426 may provide for progressive synchronization across hops between repeaters, hop specific synchronizations, and/or BM sessions with customized synchronization RS/SSB mini burst scheduling.

The RP 426 (e.g., through the RC UE 428) may communicate with the base station 402 via/with/over the PCell link 406 and the SCell/subTHz control link 410. The RC UE 428 may communicate with the AF 430 via/with/over the SCell/subTHz control link 410. The AF 430 may communicate with the base station 402 via/with/over the SCell/subTHz link 408.

The subTHz wireless communication network may include a AP 434. The AP 434 may be referred to as a repeater, a smart repeater, or a subTHz smart repeater. The AP 434 may be relatively power efficient and may utilize OOB control signaling based on the PCell. The AP 434 may be configured with similar functionality as the AP 414 and/or the RP 426. The AP 434 may have different hardware and/or capabilities than the AP 414 and/or the RP 426. The AP 434 may have a direct connection to UEs (i.e., a service link). The AP 434 may include a RC UE 428 for PCell connectivity. The RC UE 436 may be similar to the RC UE 416 described above. The AP 434 may include AF 438 for subTHz data forwarding. The AF 438 may be similar to the AF 418 described above. The AP 434 may also include sync and BR 440 over the subTHz frequency band for complementary time synchronization and/or beam refinement. The sync and BR 440 may be similar or identical to the sync and BR 420 described above. The AP 434 may provide for progressive synchronization across hops between repeaters, hop specific synchronizations, and/or BM sessions with customized synchronization RS/SSB mini burst scheduling.

The AP 434 (e.g., via the AF 438) may communicate with the AF 430 of the RP 426 via/with/over the SCell/subTHz link 408. The AP 434 (e.g., via the RC UE 436) may communicate with the base station 402 via/with/over the PCell link 406 and the SCell/subTHz control link 410. The RC UE 436 and the AF 438 may communicate via the SCell/subTHz control link 410.

The subTHz wireless communication network may include a UE 442. The AP 434 and the UE 442 may have a direct connection (i.e., a service link). The UE 442 may communicate with the base station 402 via/with/over the PCell link 406 and the SCell/subTHz control link 410. The UE 442 and the RC UE 436 may communicate via/with/over the SCell/subTHz link 408.

In one aspect, a UE (e.g., the UE 404, the UE 412, the UE 424, the UE 442) may be configured by the base station 402 with eligibility criteria for transmitting/receiving subTHz communications. If the eligibility criteria are met, the UE may transmit/receive data over a subTHz band. If the eligibility criteria are not met, the UE may transmit/receive data over a frequency band other than the subTHz band (e.g., FR1/FR2/FR4). The eligibility criteria may include the UE being located within a subTHz coverage range of the base station 402, the AP 414, the RP 426, and/or the AP 434. The eligibility criteria may include a mobility condition (e.g., a speed) of the UE being less than a threshold (i.e., semi-static subTHz beam and channel). In an example, a channel may be set to static or semi-static (i.e., the semi-static channel may change slowly over time). A serving beam may be used for relatively long durations if the channel is static or semi-static. The eligibility criteria may include the UE being capable of subTHz communications (e.g., the UE is equipped with a radio that is capable of transmitting and receiving subTHz communications). The eligibility criteria may include battery resources (e.g., a remaining battery charge) of the UE meeting a threshold. The eligibility criteria may include a volume (i.e., amount) of data that is to be transmitted or received by the UE exceeding a threshold volume (i.e., amount).

In one aspect, a UE may perform SCell/subTHz UL synchronization with a base station based on a PCell synchronization procedure. The UE may not utilize a local frequency tracking loop or frequency synchronization for the SCell/subTHz. Instead, frequency tracking (and corresponding parts per million error (referred to herein as “ppm_err”)) based on PCell connectivity may be reused/projected onto a subTHz frequency band for UL and/or DL transmissions. In an example, a PCell TA of each component in a multi hop subTHz link (e.g., the UE and each intervening smart repeater (RPs and AP) may be used to derive a SCell/subTHz TA for each component in the multi hop subTHz link. For instance, each component may separately determine a respective SCell/subTHz based on a PCell TA. In an example, the UE may determine a first SCell/subTHz TA based on a first PCell TA and a repeater connecting the UE to a base station may determine a second SCell/subTHz TA based on a second PCell TA. Per hop synchronization may allow for a relatively fast and dynamic multi hop link establishment. Some hops may be reused/shared (via time division multiplexing (TDM)) for different subTHz links/UEs/APs. Newly added hops may utilize complementary synchronization. Per hop SCell/subTHz TA determination may allow for more accurate UL/beam switching timing and PA on/off switching per hop. Prior to performing SCell/subTHz UL synchronization, SCell/subTHz DL timing synchronization may be established for each component (e.g., UEs, RPs, APs) in a subTHz link (e.g., a multi hop subTHz link). The SCell/subTHz DL timing synchronization may be a progressive synchronization. SCell/subTHz DL timing synchronization may refer to a process in which a UE (or an AP or an RP) detects a radio boundary (i.e., a time at which a radio frame starts) and a OFDM symbol boundary (i.e., a time at which an OFDM symbol starts). Furthermore, prior to performing SCell/subTHz UL synchronization, each component in the subTHz link may be continuously connected to a PCell. As such, a PCell TA for each component may be known.

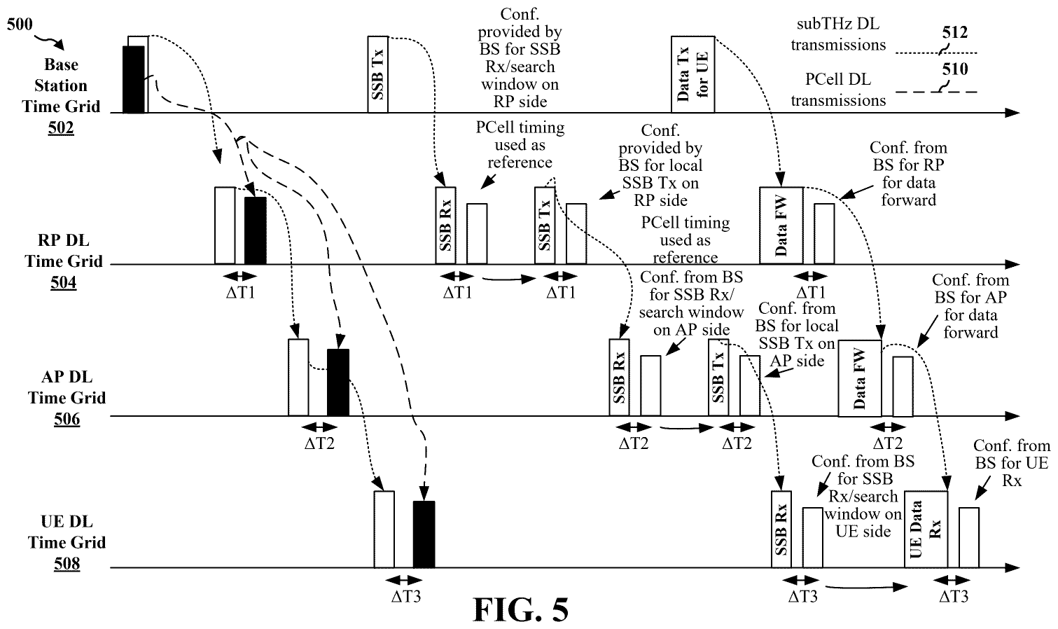

FIG. 5 is a diagram 500 illustrating an example of estimating a timing offset. The diagram 500 depicts a base station time grid 502, a RP DL time grid 504, an AP DL time grid 506, and a UE DL time grid 508. In an example, the base station time grid 502 may correspond to a time grid of the base station 402, the RP DL time grid 504 may correspond to a time grid of the RP 426, the AP DL time grid 506 may correspond to a time grid of the AP 434, and the UE DL time grid 508 may correspond to a time grid of the UE 442.

As will be described below with respect to the diagram 500, a UE (or an AP or an RP) may perform a SCell/subTHz UL time synchronization with a base station. Prior to SCell/subTHz UL time synchronization, SCell/subTHz DL synchronization may be performed. SCell/subTHz DL synchronization may be performed per hop in a progressive manner covering each hop (i.e., each component) between a base station and a UE configured for subTHz communications. SCell/subTHz DL synchronization may be performed progressively in a DL direction. Per hop synchronization may be based on a hop-specific synchronization session, that is, a first hop edge that is in sync with a previous link component in a DL direction may transmit a customized hop specific synchronization signal to a second hop edge. The second hop edge may receive the customized hop specific synchronization signal and perform synchronization procedures to synchronize with the first hop edge. Coarse timing for subTHz DL synchronization may be based on a PCell DL synchronization. A SCell/subTHz DL hop specific synchronization session configuration (for Tx and Rx sides/hop edges of the synchronization session) may be performed over a PCell link and may refer to PCell timing as a coarse timing reference. During a SCell/subTHz DL synchronization session (performed in a progressively per hop in a DL direction), a fine timing difference between PCell and SCell/subTHz timing (delta TO) may be estimated for the SCell/subTHz on a receiving UE/RP/AP (i.e., on each component of a subTHz link) with respect to a configured coarse Rx time for the SCell/subTHz. The SCell/subTHz DL synchronization session may refer to a PCell timing/slot/control signaling slot. In an example, a complete timing synchronization for components in a SubTHz link may be obtained as a superposition of a coarse SubTHz timing known based on a PCell timing synchronization and a differential delta TO estimate for the SCell/subTHz during a synchronization session with respect to an indicated synchronization session start timing. Coarse timing may refer to a PCell timeline. An estimated subTHz timing offset may be valid for a time duration until a relative SCell/subTHz and/or PCell channel delay change occurs. The time duration may encompass a relatively short subTHz data offloading session. The timing offset may be updated/maintained using additional SCell/subTHz DL synchronization sessions. The SCell/subTHz DL synchronization sessions may be scheduled from time to time (e.g., periodically) to accommodate a relatively long lasting SubTHz data offloading session. For instance, the SCell/subTHz may not maintain an independent time tracking loop (TTL) and a time shift/drift captured on the PCell may be propagated to the SCell/subTHz.

Additionally, as will be described below with respect to the diagram 500, a UE may perform SCell/subTHz synchronization with a base station based on PCell synchronization procedures. The UE may not utilize a local frequency tracking loop or frequency synchronization for the SCell/subTHz. Instead, frequency tracking (and corresponding ppm_err) based on PCell connectivity may be reused/projected on to a subTHz frequency band. In an example, a PCell TTL and PCell timing may be utilized as a coarse timing reference for an SCell/subTHz. For instance, an independent TTL may not be employed on the SCell/subTHz and a complimentary fine timing estimation (delta timing offset) with respect to PCell timing may be utilized for SCell/subTHz time synchronization. SCell/subTHz time synchronization may be performed on a dedicated synchronization RS and/or SSB mini-bursts transmitted during a SCell/subTHz hop specific synchronization and BM session (or sessions). A subTHz time synchronization session (which may include a BM synchronization) may be scheduled by a PCell on a per link activation, on a per defined time period/periodically along a relatively long-lasting active subTHz-based data offloading session, or as an event driven synchronization session scheduling during an active data offloading session in response to a list of events.

Furthermore, as will be described below with respect to the diagram 500, a SCell/subTHz DL timing synchronization session may occur. The SCell/subTHz DL timing synchronization session for an Rx side of the UE (and a Tx side of intermediate hops) may be performed over a PCell link and by referring to PCell timing characteristics. PCell-based coarse timing synchronization/referencing may define time search boundaries/time uncertainty for a subTHz DL local synchronization session per each SCell/subTHz link activation. Fine timing (i.e., a delta TO) may be estimated for an SCell/subTHz on a receiving UE/RP with respect to a configured Rx time for a SCell/subTHz DL timing synchronization session based on a PCell timing/slot/control signaling slot. In an example, the SCell/subTHz may not have an independent TTL. SCell/subTHz DL timing synchronization may be obtained based on coarse timing of the PCell and a locally estimated relative TO of the SCell/subTHz. The SCell/subTHz DL timing synchronization may be established using a progressive synchronization approach on a per multi hop link basis.

As illustrated in the diagram 500, each component (RP, AP, and UE) may be synchronized with the PCell based on PCell DL transmissions 510. Synchronized PCell DL timing may be used as a coarse/initial timing reference for SCell/subTHz. A UE (or a AP or a RP) may track a ppm offset. The UE/AP/RP may correct frequency offsets of the SCell/subTHz based on the ppm offset. The UE/AP/RP may adjust a sampling rate to avoid cumulative time drifts if a same phased locked loop (PLL) reference is used for the PCell and the SCell/subTHz and if the PCell and SCell/subTHz utilize quasi-static channels where UE mobility is under a threshold. PCell and SCell/subTHz transmissions may be propagated for different channels (at least for the AP or the UE) and may have a relative timing offset. This may lead to SCell/subTHz DL local Rx timing being shifted compared to a PCell local Rx timing grid. A UE/AP/RP may estimate such a relative TO. The relative TO may be tracked by a subTHz DL synchronization procedure during an active traffic offloading session.

With reference to the base station time grid 502, the base station may transmit an SSB to the RP via a subTHz DL transmission 512. Referring to the RP DL time grid 504, the RP may receive the SSB. The RP may estimate a timing offset ΔT1 based on the SSB. A subTHz DL timing grid may be in sync on the RP side according to equation (I) below.

$${{T}_{R P} ( subTHz )}_{DL} = {{T}_{R P} ( P C e l l )}_{D L} - Δ T 1 \qquad ( I )$$

A base station configuration referencing a PCell time grid can be translated to a subTHz DL grid on the RP side. The RP may receive a confirmation provided by the base station for a SSB Rx/search window on the RP side, where PCell timing may be used as a reference. The RP may receive a confirmation provided by the base station for a local SSB Tx on the RP side, where PCell timing may be used as a reference. The RP may forward a data transmission. The RP may receive a confirmation from the base station for data forwarding.

With reference to the AP DL time grid 506, the AP may receive an SSB forwarded by the RP via a subTHz DL transmission 512. The AP may estimate a timing offset ΔT2 based on the SSB. A subTHz DL timing grid may be in sync on the AP side according to equation (II) below.

$${{T}_{A P} ( subTHz )}_{DL} = {{T}_{A P} ( P C e l l )}_{D L} - Δ T 2 \qquad ( II )$$

A base station configuration referencing a PCell time grid can be translated to a subTHz DL grid on the AP side. The AP may receive a confirmation provided by the base station for a SSB Rx/search window on the AP side, where PCell timing may be used as a reference. The AP may receive a confirmation provided by the base station for a local SSB Tx on the AP side, where PCell timing may be used as a reference. The AP may forward a data transmission. The AP may receive a confirmation from the base station for data forwarding.

With reference to the UE DL time grid 508, the UE may receive an SSB forwarded by the AP via a subTHz DL transmission 512. The UE may estimate a timing offset ΔT3 based on the SSB. A subTHz DL timing grid may be in sync on the AP side according to equation (III) below.

$${{T}_{U E} ( subTHz )}_{DL} = {{T}_{U E} ( P C e l l )}_{D L} - Δ T 3 \qquad ( III )$$

A base station configuration referencing a PCell time grid can be translated to a subTHz DL grid on the UE side. The UE may receive a confirmation provided by the base station for a SSB Rx/search window on the UE side, where PCell timing may be used as a reference. The UE may receive a confirmation provided by the base station for a local SSB Tx on the UE side, where PCell timing may be used as a reference. The UE may receive a data transmission. The UE may receive a confirmation from the base station for data reception.

Although the procedure illustrated in the diagram 500 depicts a SCell/subTHz DL timing synchronization session for a UE that is connected to a base station via a RP and an AP (i.e., 3 links), the procedure may also be applicable for direct connections between a UE and a SCell/subTHz (i.e., 1 link), as well as other numbers of links (e.g., 2 links, 4 links, etc.).

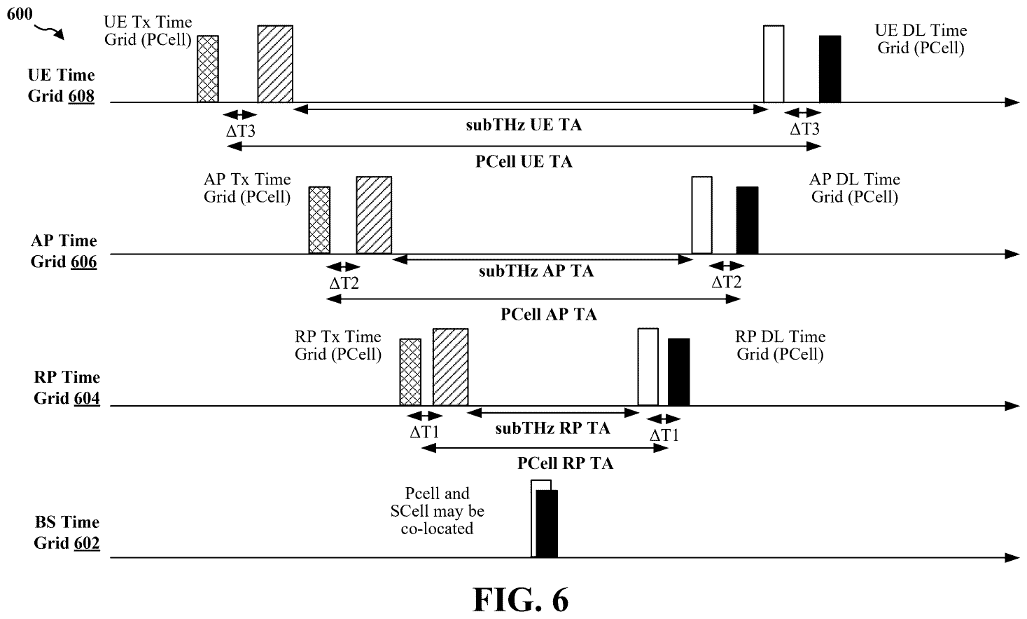

FIG. 6 is a diagram 600 illustrating an example of deriving a TA. The diagram 600 depicts a base station time grid 602, a RP time grid 604, an AP time grid 606, and a UE time grid 608. In an example, the base station time grid 602 may correspond to a time grid of the base station 402, the RP time grid 604 may correspond to a time grid of the RP 426, the AP time grid 606 may correspond to a time grid of the AP 434, and the UE time grid 608 may correspond to a time grid of the UE 442.

As will be discussed below with respect to the diagram 600, if time reciprocity exists between a PCell and an SCell/subTHz (or if a known time difference exists between DL and UL determined via a calibration procedure), a SCell/subTHz TA may be derived for each subTHz link component (e.g., a UE, RP(s), AP(s)) using a PCell TA for each component and an estimated DL delta TO between the PCell and the SCell/subTHz. The PCell and the SCell/subTHz may be co-located. If the PCell and the SCell/subTHz are co-located, the PCell and the SCell/subTHz may be located in the same place (e.g., a tower/RH) and transmissions associated with the PCell and the SCell/subTHz may originate from the same point in space. The UE/RP/AP may maintain a continuous connection with the PCell and as such, the UE/RP/AP may obtain the PCell TA from the PCell. The estimated DL delta TO for each component may be obtained via the SCell/subTHz DL timing synchronization session described above in the description of FIG. 5. The estimated DL delta TO may be valid during a limited time for a subTHz data offloading session. If a length of the subTHz data offloading session exceeds a threshold time, additional SCell/subTHz DL timing synchronization sessions may be scheduled to adjust the estimated DL delta TO. Such an approach may result in a UE/RP/AP obtaining a SCell/subTHz TA without the UE/RP/AP utilizing a RS transmission in UL or another estimation procedure. As such, UL synchronization may be achieved by a UE/RP/AP without a RACH signal transmission and/or a RACH procedure. Registration/initial logical connection related procedures for the SCell/subTHz may be performed over a PCell link prior to activation of the SCell/subTHz. After the UE/RP/AP obtains a SCell/subTHz TA, the UE/RP/AP may utilize the SCell/subTHz TA for UL transmissions via the SCell/subTHz.

With reference to the UE time grid 608, the UE may obtain a timing offset ΔT3 via the SCell/subTHz DL timing synchronization session described above in the description of FIG. 6. Furthermore, as the UE may have a continuous connection with the PCell, the UE may obtain a TA for the PCell (TA_{UE}(PCell)) from the PCell.

The UE may derive a TA for the SCell/subTHz (TA_{UE}(subTHz)) using equation (IV) below.

$$T {A}_{U E} ( subTHz ) = {TA}_{U E} ( P C e l l ) - 2 Δ T 3 \qquad ( IV )$$

With reference to the AP time grid 606, the AP may obtain a timing offset ΔT2 via the SCell/subTHz DL timing synchronization session described above in the description of FIG. 5. Furthermore, as the AP may have a continuous connection with the PCell, the AP may obtain a TA for the PCell (TA_{AP}(PCell)) from the PCell.

The AP may derive a TA for the SCell/subTHz (TA_{AP}(subTHz)) using equation (V) below.

$$T {A}_{A P} ( subTHz ) = {TA}_{A P} ( P C e l l ) - 2 Δ T 2 \qquad ( V )$$

With reference to the RP time grid 604, the RP may obtain a timing offset ΔT1 via the SCell/subTHz DL timing synchronization session described above in the description of FIG. 5. Furthermore, as the RP may have a continuous connection with the PCell, the RP may obtain a TA for the PCell (TA_{RP}(PCell)) from the PCell.

The RP may derive a TA for the SCell/subTHz (TA_{RP}(subTHz)) using equation (VI) below.

$$T {A}_{R P} ( subTHz ) = {TA}_{R P} ( PCell ) - 2 Δ T 1 \qquad ( VI )$$

Although the procedure illustrated in the diagram 700 depicts a SCell/subTHz UL synchronization session for a UE that is connected to a base station via a RP and an AP (i.e., 3 links), the procedure may also be applicable for direct connections between a UE and a SCell/subTHz (i.e., 1 link), as well as other numbers of links (e.g., 2 links, 4 links, etc.).

In one aspect, the SCell/subTHz UL synchronization session described above may be utilized for initial subTHz TA acquisition. A regular TA adaptation procedure for a UE (during an active UL offloading session) may be performed in addition to the SCell/subTHz UL synchronization session.

In one aspect, subTHz channel delay may be different than PCell channel delay for the AP and the UE due to a lack of direct LOS with the base station. In such an aspect, a relative TO between subTHz and PCell timing may be considered for both DL synchronization and for SCell/subTHz TA derivation.

In one aspect, there may be a time shift between PCell and SCell/subTHz frame counting.

The SCell/subTHz UL synchronization session is associated with various advantages for a UE and a base station. First, as the SCell/subTHz TA may be derived based on a known PCell TA, the SCell/subTHz UL synchronization session may enable a UE to determine a SCell/subTHz without performing a RACH procedure and without the UE utilizing an UL RS transmission. Second, the SCell/subTHz UL synchronization session may enable the UE to determine a SCell/subTHz TA without the UE receiving SCell/subTHz signaling from the base station. As described above, a UE/AP/RP may determine a SCell/subTHz TA autonomously and locally, that is, each UE/AP/RP may evaluate/determine its own SCell/subTHz TA. The SCell/subTHz UL synchronization session may allow for relatively fast subTHz link activation/deactivation for eligible UEs and may be associated with lower complexity, lower power usage, and lower latency penalties. The SCell/subTHz UL synchronization session may support a burst activity pattern with dynamic activation/deactivation of subTHz links that may improve power efficiency of SubTHz deployments.

In one aspect, the SCell/subTHz UL synchronization session may not be associated with a full scope InitAcq procedure for subTHz in general. Instead, the SCell/subTHz UL synchronization session may be associated with a reduced power subTHz link activation with a reduced scope: initial search/sync per activation based on a scheduled and customized per hop SSB mini burst (frequency offset (FO), coarse timing, coarse beam/beams list may be known and determined based on PCell connectivity and configured over the PCell for Tx and Rx sides of a per hop subTHz synchronization session). Data associated with the SCell/subTHz may be transmitted/received over the PCell (including RRC connection/registration, subTHz offloading, link activation/deactivation, BM/sync RS/LA RS, DL/UL scheduling, and UL feedback/reports).

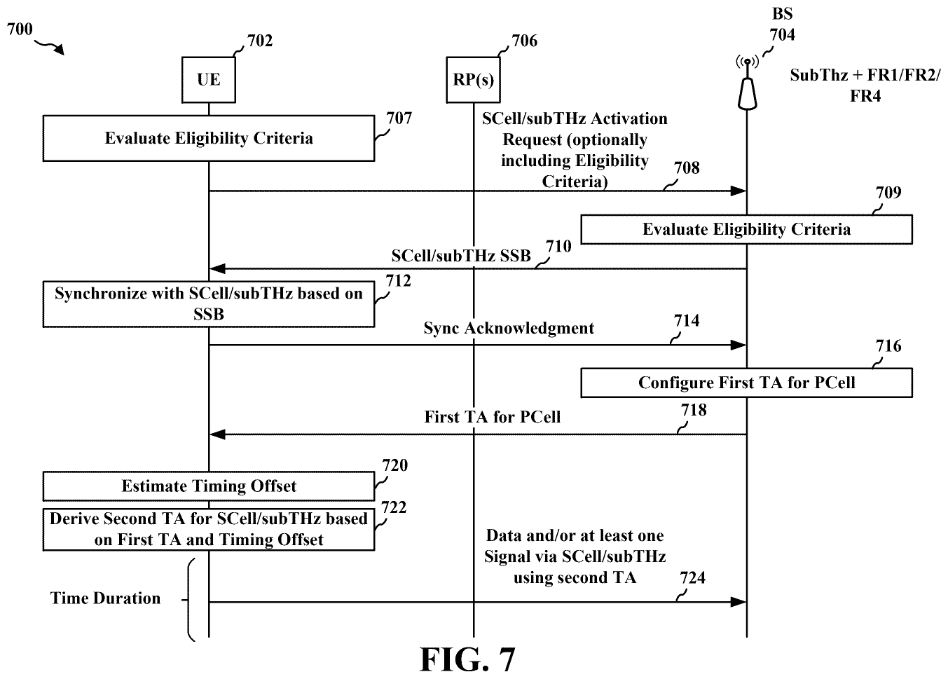

FIG. 7 is a diagram 700 illustrating an example communications flow between a UE 702 and a base station 704. In an example, the UE 702 may be the UE 404, the UE 424, or the UE 442. In another example, the base station 704 may be the base station 402. The UE 702 and the base station 704 may be capable of communicating via FR1/FR2/FR4 (i.e., a PCell) and via a subTHz frequency band (i.e., an SCell). The UE 702 may have a continuous connection to the PCell and a non-continuous connection to the SCell. Communications between the UE 702 and the base station 704 may be transmitted/received via one or more RPs 706. In an example, the one or more RPs 706 may include the AP 414, the RP 426, and/or the AP 434.

At 707, the UE 702 may evaluate eligibility criteria for subTHz communications. The eligibility criteria may be or include the eligibility criteria described above in the description of the diagram 400. At 708, the UE may transmit an SCell/subTHz activation request for the base station 704. The SCell/subTHz activation request may include the eligibility criteria. In an example, the SCell/subTHz activation request may include indications of battery resources of the UE 702, an estimated amount of data that is to be transmitted or receive by the UE 702, etc. At 709, the base station 704 may evaluate the eligibility criteria with respect to the UE 702. At 710, upon determining that the UE 702 meets the eligibility criteria, the base station 704 may transmit a SCell/subTHz SSB for the UE 702. At 712, the UE 702 may synchronize with the SCell/subTHz based on the SSB transmitted at 710. At 714, upon synchronizing with the SCell/subTHz, the UE 702 may transmit a sync acknowledgment for the base station 704.

At 716, the base station may configure a first TA for the PCell. At 718, the base station 704 may transmit the first TA for the UE 702. At 720, the UE 702 may estimate a timing offset between the PCell and the SCell/subTHz. The UE 702 may estimate the timing offset based on the SCell/subTHz SSB transmitted at 710. In an example, the UE 702 may estimate the timing offset as described above in the description of FIG. 5. The timing offset may be valid for a time duration. At 722, the UE 702 may derive a second TA for the SCell/subTHz based on the first TA and the timing offset. In an example, the UE 702 may estimate the timing offset as described above in the description of FIG. 6. At 724, the UE 702 may transmit data and/or at least one signal via the SCell/subTHz using the second TA. The UE 702 may transmit the data and/or the at least one signal within the time duration.

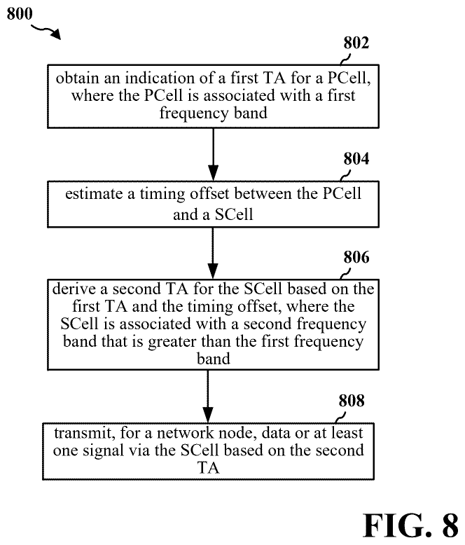

FIG. 8 is a flowchart 800 of a method of wireless communication. The method may be performed by a UE (e.g., the UE 104, the UE 350, the UE 404, the UE 424, the UE 442, the UE 702, the apparatus 1204). In an example, the method may be performed by the TA deriving component 198. The method may be associated with various technical advantages at the UE, such as reduced UE power consumption, reduced subTHz signaling via derivation of a subTHz TA based on a FR1/FR2/FR4 TA, and reduced latency.

At 802, the UE obtains an indication of a first TA for a PCell, where the PCell is associated with a first frequency band. For example, FIG. 7 at 718 shows the UE 702 obtaining a first TA for a PCell. In an example, the first TA may be the PCell UE TA illustrated in FIG. 6. In another example, as illustrated in FIG. 4, the PCell may be associated with FR1/FR2/FR4. For example, 802 may be performed by the TA deriving component 198.

At 804, the UE estimates a timing offset between the PCell and a SCell. For example, FIG. 7 at 720 shows that the UE 702 may estimate a timing offset. In another example, FIG. 5 shows that a UE may estimate a timing offset. For example, 804 may be performed by the TA deriving component 198.

At 806, the UE derives a second TA for the SCell based on the first TA and the timing offset, where the SCell is associated with a second frequency band that is greater than the first frequency band. For example, FIG. 7 at 722 shows that the UE 702 may derive a second TA for a SCell/subTHz based on the first TA obtained at 718 and the timing offset estimated at 720. In an example, the second frequency band may be a subTHz frequency band. For example, 806 may be performed by the TA deriving component 198.

At 808, the UE transmits, for a network node, data or at least one signal via the SCell based on the second TA. For example, FIG. 7 at 724 shows that the UE 702 may transmit data and/or at least signal via the SCell/subTHz using the second TA derived at 722. In an example, the network node may be the base station 704. For example, 808 may be performed by the TA deriving component 198.

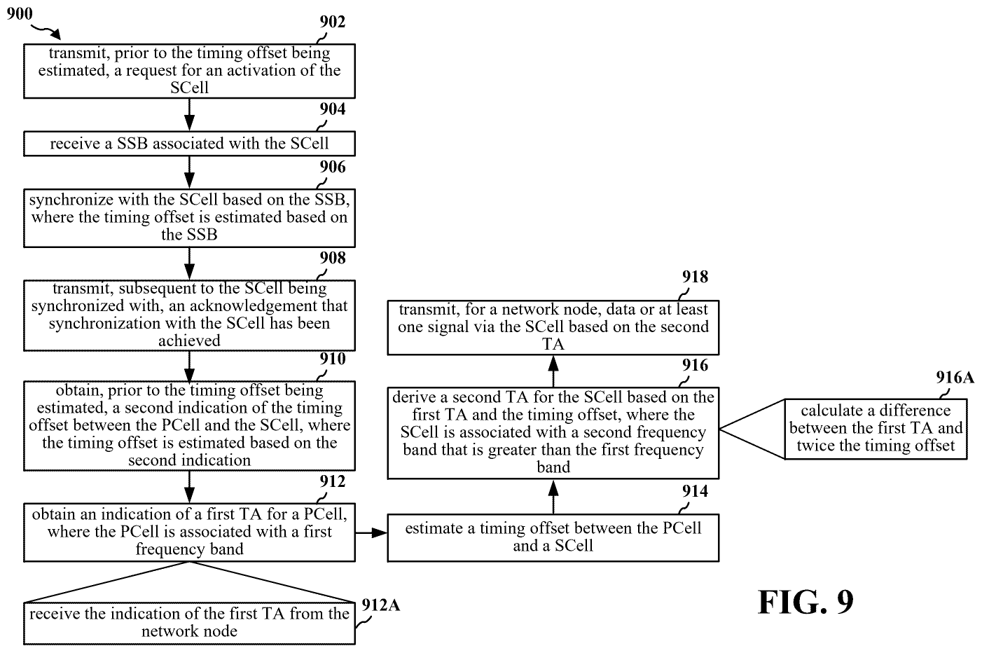

FIG. 9 is a flowchart 900 of a method of wireless communication. The method may be performed by a UE (e.g., the UE 104, the UE 350, the UE 404, the UE 424, the UE 442, the UE 702, the apparatus 1204). In an example, the method (including the various aspects detailed below) may be performed by the TA deriving component 198. The method may be associated with various technical advantages at the UE, such as reduced UE power consumption, reduced subTHz signaling via derivation of a subTHz TA based on a FR1/FR2/FR4 TA, and reduced latency.

At 912, the UE obtains an indication of a first TA for a PCell, where the PCell is associated with a first frequency band. For example, FIG. 7 at 718 shows the UE 702 obtaining a first TA for a PCell. In an example, the first TA may be the PCell UE TA illustrated in FIG. 6. In another example, as illustrated in FIG. 4, the PCell may be associated with FR1/FR2/FR4. For example, 912 may be performed by the TA deriving component 198.

At 914, the UE estimates a timing offset between the PCell and a SCell. For example, FIG. 7 at 720 shows that the UE 702 may estimate a timing offset. In another example, FIG. 5 shows that a UE may estimate a timing offset. For example, 914 may be performed by the TA deriving component 198.

At 916, the UE derives a second TA for the SCell based on the first TA and the timing offset, where the SCell is associated with a second frequency band that is greater than the first frequency band. For example, FIG. 7 at 722 shows that the UE 702 may derive a second TA for a SCell/subTHz based on the first TA obtained at 718 and the timing offset estimated at 720. In an example, the second frequency band may be a subTHz frequency band. For example, 916 may be performed by the TA deriving component 198.

At 918, the UE transmits, for a network node, data or at least one signal via the SCell based on the second TA. For example, FIG. 7 at 724 shows that the UE 702 may transmit data and/or at least signal via the SCell/subTHz using the second TA derived at 722. In an example, the network node may be the base station 704. For example, 918 may be performed by the TA deriving component 198.

In one aspect, the second frequency band may be a subTHz frequency band that is FR5. For example, the second frequency band may be the subTHz frequency band illustrated in FIG. 4 and FIG. 7.

In one aspect, at 912A, obtaining the indication of the first TA may include receiving the indication of the first TA from the network node. For example, FIG. 7 at 718 shows that the UE 702 may receive a first TA from the base station 704. For example, 912A may be performed by the TA deriving component 198.

In one aspect, at 910, the UE may obtain, prior to the timing offset being estimated, a second indication of the timing offset between the PCell and the SCell, where the timing offset may be estimated based on the second indication. In an example, referring to FIG. 7, the second indication of the timing offset may be an SCell/subTHz SSB obtained by the UE 702 at 710. For example, 910 may be performed by the TA deriving component 198.

In one aspect, the timing offset between the PCell and the SCell may be a downlink timing offset. For example, FIG. 5 shows that a timing offset may be a DL timing offset.

In one aspect, the data or the at least one signal may be transmitted via the SCell to one or more repeaters. For example, FIG. 7 shows that the data and/or the at least one signal may be transmitted via an SCell to the one or more RPs 706. In another example, the one or more repeaters may be or include the AP 414, the RP 426, and/or the AP 434 illustrated in FIG. 4.

In one aspect, each of the one or more repeaters may be associated with a respective TA for communication via the SCell. For instance, FIG. 6 shows that an AP may be associated with a subTHz AP TA and that a RP may be associated with a subTHz RP TA.

In one aspect, the timing offset may be valid for a time duration, where the data or the at least one signal may be transmitted within the time duration. For example, FIG. 7 illustrates that the data and/or the at least one signal transmitted at 724 may be transmitted within a time duration.

In one aspect, the PCell and the SCell may be co-located. For example, FIG. 6 illustrates that a PCell and an SCell may be co-located.

In one aspect, at 916A, deriving the second TA for the SCell may include calculating a difference between the first TA and twice the timing offset. For example, in the UE time grid 608 in FIG. 6, the subTHz UE TA may be equal to the PCell UE TA minus twice ΔT3.

In one aspect, at 902, the UE may transmit, prior to the timing offset being estimated, a request for an activation of the SCell. For example, FIG. 7 at 708 shows that the UE may transmit an SCell/subTHz activation request. For example, 902 may be performed by the TA deriving component 198.

In one aspect, at 904, the UE may receive a SSB associated with the SCell. For example, FIG. 7 at 710 shows that the UE 702 may receive an SCell/subTHz SSB 710. In another example, FIG. 5 illustrates that an SSB may be associated with a subTHz frequency band. For example, 904 may be performed by the TA deriving component 198.

In one aspect, at 906, the UE may synchronize with the SCell based on the SSB, where the timing offset may be estimated based on the SSB. For example, FIG. 7 at 712 shows that the UE 702 may synchronize with an SCell/subTHz based on the SSB received at 710. In another example, the timing offset estimated at 720 may be estimated based on the SSB received at 710. For example, 906 may be performed by the TA deriving component.

In one aspect, at 908, the UE may transmit, subsequent to the SCell being synchronized with, an acknowledgement that synchronization with the SCell has been achieved. For example, FIG. 7 at 714 shows that the UE 702 may transmit a sync acknowledgment. For example, 908 may be performed by the TA deriving component.

In one aspect, the SSB associated with the SCell may correspond to a certain repeater in a set of repeaters. For example, FIG. 5 illustrates subTHz SSBs that correspond to an RP associated with the RP DL time grid 504 and to an AP associated with the AP DL time grid 506.

In one aspect, the UE may have a continuous connection to the PCell, and the UE may have a non-continuous connection to the SCell. For example, FIG. 4 shows that the UE 404 may have a continuous connection to a PCell via the PCell link 406 and that the UE 404 may have a non-continuous connection to an SCell/subTHz via an SCell/subTHz link 408 and/or a SCell/subTHz control link 410.

In one aspect, the first frequency band may be at least one of: FR1, FR2, or FR4. For example, FIG. 4 shows that the first frequency band may be FR1/FR2/FR4. In another example, FIG. 7 shows that the first frequency band may be FR1/FR2/FR4.

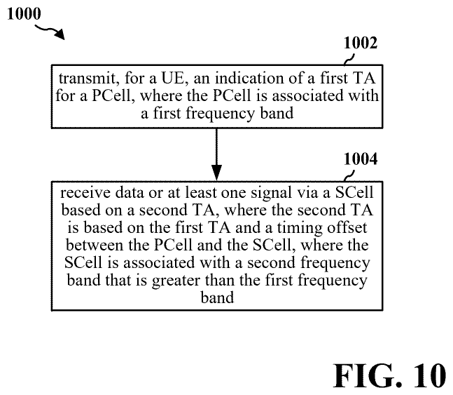

FIG. 10 is a flowchart 1000 of a method of wireless communication. The method may be performed by a network node (e.g., the base station 102, the base station 402, the base station 704, the network entity 1202). In an example, the method may be performed by the TA component 199. The method may be associated with various advantages at the network node, such as reduced signaling overhead.

At 1002, the network node transmits, for a UE, an indication of a first TA for a PCell, where the PCell is associated with a first frequency band. For example, FIG. 7 at 718 shows that the base station 704 may transmit a first TA for a PCell. In an example illustrated in FIG. 4, the PCell may be associated with FR1/FR2/FR4. In an example, the first TA may be the PCell UE TA illustrated in FIG. 6. For example, 1002 may be performed by the TA component 199.

At 1004, the network node receives data or at least one signal via a SCell based on a second TA, where the second TA is based on the first TA and a timing offset between the PCell and the SCell, where the SCell is associated with a second frequency band that is greater than the first frequency band. For example, FIG. 7 at 724 shows the base station 704 receiving data and/or at least one signal via a SCell/subTHz based on a second TA. In an example illustrated in FIG. 4, the SCell may be associated with a subTHz frequency band. For example, 1004 may be performed by the TA component 199.

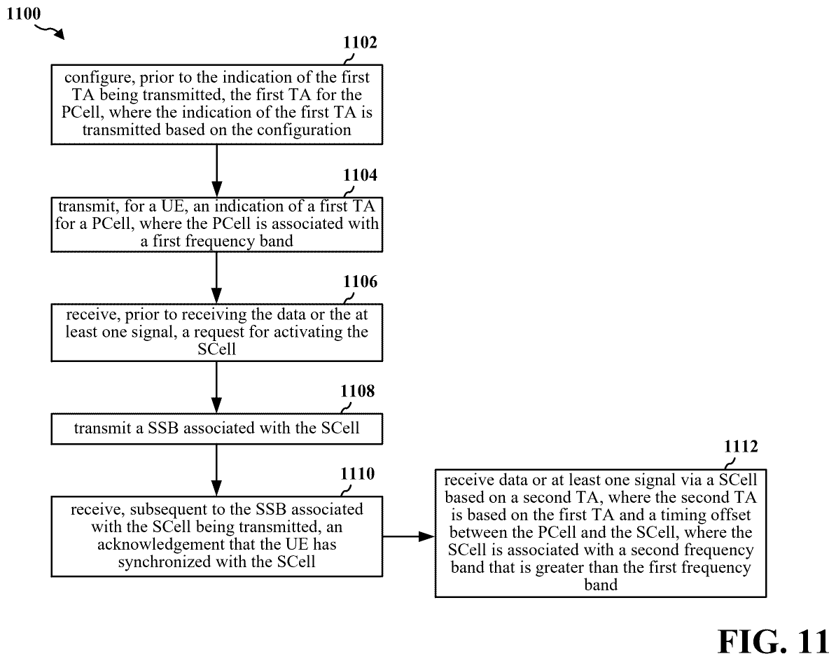

FIG. 11 is a flowchart 1100 of a method of wireless communication. The method may be performed by a network node (e.g., the base station 102, the base station 402, the base station 704, the network entity 1202). In an example, the method (including the various aspects detailed below) may be performed by the TA component 199. The method may be associated with various advantages at the network node, such as reduced signaling overhead.

At 1104, the network node transmits, for a UE, an indication of a first TA for a PCell, where the PCell is associated with a first frequency band. For example, FIG. 7 at 718 shows that the base station 704 may transmit a first TA for a PCell. In an example illustrated in FIG. 4, the PCell may be associated with FR1/FR2/FR4. In an example, the first TA may be the PCell UE TA illustrated in FIG. 6. For example, 1104 may be performed by the TA component 199.

At 1112, the network node receives data or at least one signal via a SCell based on a second TA, where the second TA is based on the first TA and a timing offset between the PCell and the SCell, where the SCell is associated with a second frequency band that is greater than the first frequency band. For example, FIG. 7 at 724 shows the base station 704 receiving data and/or at least one signal via a SCell/subTHz based on a second TA. In an example illustrated in FIG. 4, the SCell may be associated with a subTHz frequency band. For example, 1112 may be performed by the TA component 199.

In one aspect, the second frequency band may be a subTHz frequency band that is FR5. For example, the second frequency band may be the subTHz frequency band illustrated in FIG. 4 and FIG. 7.

In one aspect, the timing offset between the PCell and the SCell may be a downlink timing offset. For example, FIG. 5 shows that a timing offset may be a DL timing offset.

In one aspect, where the data or the at least one signal may be received via the SCell from one or more repeaters. For example, FIG. 7 shows that the data and/or the at least one signal may be received via an SCell via the one or more RPs 706. In another example, the one or more repeaters may be or include the AP 414, the RP 426, and/or the AP 434 illustrated in FIG. 4.

In one aspect, each of the one or more repeaters may be associated with a respective TA for communication via the SCell. For instance, FIG. 6 shows that an AP may be associated with a subTHz AP TA and that a RP may be associated with a subTHz RP TA.

In one aspect, the timing offset may be valid for a time duration, where the data or the at least one signal may be received within the time duration. For example, FIG. 7 illustrates that the data and/or the at least one signal received at 724 may be received within a time duration.

In one aspect, the PCell and the SCell may be co-located. For example, FIG. 6 illustrates that a PCell and an SCell may be co-located.

In one aspect, the second TA may be a difference between the first TA and twice the timing offset. For example, in the UE time grid 608 in FIG. 6, the subTHz UE TA may be equal to the PCell UE TA minus twice ΔT3.

In one aspect, at 1106, the network node may receive, prior to the data or the at least one signal being received, a request for an activation of the SCell. For example, FIG. 7 at 708 shows that the base station 704 may receive a SCell/subTHz activation request. For example, 1106 may be performed by the TA component 199.

In one aspect, at 1108, the network node may transmit a SSB associated with the SCell. For example, FIG. 7 at 710 shows that the base station 704 may transmit a SCell/subTHz SSB. For example, 1108 may be performed by the TA component 199.

In one aspect, at 1110, the network node may receive, subsequent to the SSB associated with the SCell being transmitted, an acknowledgement that the UE has synchronized with the SCell. For example, FIG. 7 at 714 shows that the base station 704 may receive a sync acknowledgment indicating that the UE has synchronized with the SCell. For example, 1110 may be performed by the TA component 199.

In one aspect, the network node may have a continuous connection with the UE via the PCell and the network node may have a non-continuous connection with the UE via the SCell. For example, FIG. 4 shows that the base station 402 may have a continuous connection to the UE 404 via the PCell link 406 and that the base station 402 may have a non-continuous connection to the UE 404 via a SCell/subTHz link 408 and/or a SCell/subTHz control link 410.

In one aspect, where the first frequency band may be at least one of: FR1, FR2, or FR4. For example, FIG. 4 shows that the first frequency band may be FR1/FR2/FR4. In another example, FIG. 7 shows that the first frequency band may be FR1/FR2/FR4.

In one aspect, at 1102, the network node may configure, prior to the indication of the first TA being transmitted, the first TA for the PCell, where the indication of the first TA may be transmitted based on the configuration. For example, FIG. 7 at 716 shows that the base station 704 may configure a first TA for a PCell. For example, 1102 may be performed by the TA component 199.

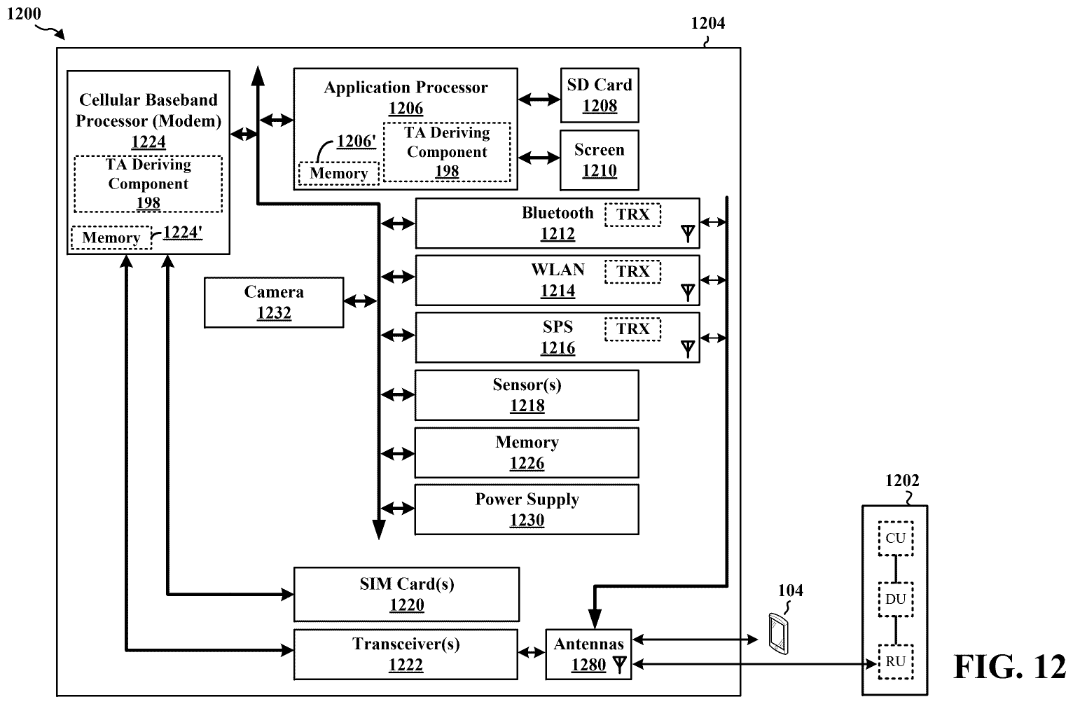

FIG. 12 is a diagram 1200 illustrating an example of a hardware implementation for an apparatus 1204. The apparatus 1204 may be a UE, a component of a UE, or may implement UE functionality. In some aspects, the apparatus 1204 may include a cellular baseband processor 1224 (also referred to as a modem) coupled to one or more transceivers 1222 (e.g., cellular RF transceiver). The cellular baseband processor 1224 may include on-chip memory 1224′. In some aspects, the apparatus 1204 may further include one or more subscriber identity modules (SIM) cards 1220 and an application processor 1206 coupled to a secure digital (SD) card 1208 and a screen 1210. The application processor 1206 may include on-chip memory 1206′. In some aspects, the apparatus 1204 may further include a Bluetooth module 1212, a WLAN module 1214, an SPS module 1216 (e.g., GNSS module), one or more sensor modules 1218 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1226, a power supply 1230, and/or a camera 1232. The Bluetooth module 1212, the WLAN module 1214, and the SPS module 1216 may include an on-chip transceiver (TRX) (or in some cases, just a receiver (RX)). The Bluetooth module 1212, the WLAN module 1214, and the SPS module 1216 may include their own dedicated antennas and/or utilize the antennas 1280 for communication. The cellular baseband processor 1224 communicates through the transceiver(s) 1222 via one or more antennas 1280 with the UE 104 and/or with an RU associated with a network entity 1202. The cellular baseband processor 1224 and the application processor 1206 may each include a computer-readable medium/memory 1224′, 1206′, respectively. The additional memory modules 1226 may also be considered a computer-readable medium/memory. Each computer-readable medium/memory 1224′, 1206′, 1226 may be non-transitory. The cellular baseband processor 1224 and the application processor 1206 are each responsible for general processing, including the execution of software stored on the computer-readable medium/memory. The software, when executed by the cellular baseband processor 1224/application processor 1206, causes the cellular baseband processor 1224/application processor 1206 to perform the various functions described supra. The computer-readable medium/memory may also be used for storing data that is manipulated by the cellular baseband processor 1224/application processor 1206 when executing software. The cellular baseband processor 1224/application processor 1206 may be a component of the UE 350 and may include the memory 360 and/or at least one of the TX processor 368, the RX processor 356, and the controller/processor 359. In one configuration, the apparatus 1204 may be a processor chip (modem and/or application) and include just the cellular baseband processor 1224 and/or the application processor 1206, and in another configuration, the apparatus 1204 may be the entire UE (e.g., see 350 of FIG. 3) and include the additional modules of the apparatus 1204.

As discussed supra, the TA deriving component 198 is configured to obtain an indication of a first TA for a PCell, where the PCell is associated with a first frequency band. The TA deriving component 198 is configured to estimate a timing offset between the PCell and a SCell. The TA deriving component 198 is configured to derive a second TA for the SCell based on the first TA and the timing offset, where the SCell is associated with a second frequency band that is greater than the first frequency band. The TA deriving component 198 is configured to transmit, for a network node, data or at least one signal via the SCell based on the second TA. The TA deriving component 198 may be within the cellular baseband processor 1224, the application processor 1206, or both the cellular baseband processor 1224 and the application processor 1206. The TA deriving component 198 may be one or more hardware components specifically configured to carry out the stated processes/algorithm, implemented by one or more processors configured to perform the stated processes/algorithm, stored within a computer-readable medium for implementation by one or more processors, or some combination thereof. As shown, the apparatus 1204 may include a variety of components configured for various functions. In one configuration, the apparatus 1204, and in particular the cellular baseband processor 1224 and/or the application processor 1206, includes means for obtaining an indication of a first TA for a PCell, where the PCell is associated with a first frequency band. In one configuration, the apparatus 1204, and in particular the cellular baseband processor 1224 and/or the application processor 1206, includes means for estimating a timing offset between the PCell and a SCell. In one configuration, the apparatus 1204, and in particular the cellular baseband processor 1224 and/or the application processor 1206, includes means for deriving a second TA for the SCell based on the first TA and the timing offset, where the SCell is associated with a second frequency band that is greater than the first frequency band. In one configuration, the apparatus 1204, and in particular the cellular baseband processor 1224 and/or the application processor 1206, includes means for transmitting, for a network node, data or at least one signal via the SCell based on the second TA. In one configuration, the means for obtaining the indication of the first TA include means for receiving the indication of the first TA from the network node. In one configuration, the apparatus 1204, and in particular the cellular baseband processor 1224 and/or the application processor 1206, includes means for obtaining, prior to estimating the timing offset, a second indication of the timing offset between the PCell and the SCell, where the timing offset is estimated based on the second indication. In one configuration, the means for deriving the second TA for the SCell include means for calculating a difference between the first TA and twice the timing offset. In one configuration, the apparatus 1204, and in particular the cellular baseband processor 1224 and/or the application processor 1206, includes means for transmitting, prior to estimating the timing offset, a request for activating the SCell. In one configuration, the apparatus 1204, and in particular the cellular baseband processor 1224 and/or the application processor 1206, includes means for receiving a SSB associated with the SCell. In one configuration, the apparatus 1204, and in particular the cellular baseband processor 1224 and/or the application processor 1206, includes means for synchronizing with the SCell based on the SSB, where the timing offset is estimated based on the SSB. In one configuration, the apparatus 1204, and in particular the cellular baseband processor 1224 and/or the application processor 1206, includes means for transmitting, subsequent to synchronizing with the SCell, an acknowledgement that synchronization with the SCell has been achieved. The means may be the TA deriving component 198 of the apparatus 1204 configured to perform the functions recited by the means. As described supra, the apparatus 1204 may include the TX processor 368, the RX processor 356, and the controller/processor 359. As such, in one configuration, the means may be the TX processor 368, the RX processor 356, and/or the controller/processor 359 configured to perform the functions recited by the means.

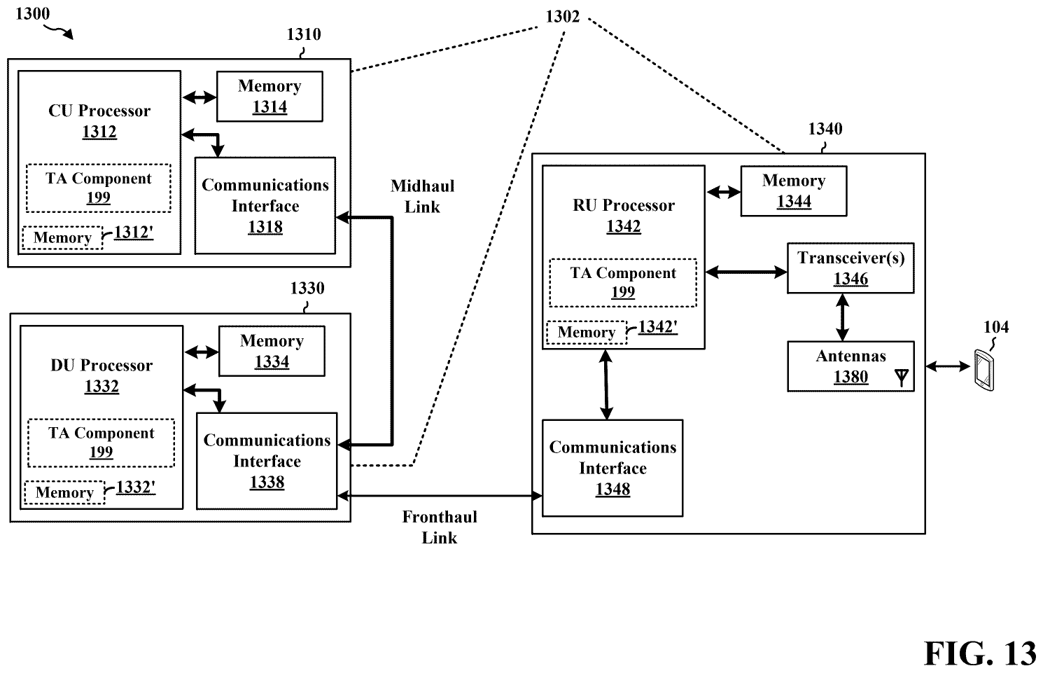

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the TA component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include a CU processor 1312. The CU processor 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include a DU processor 1332. The DU processor 1332 may include on-chip memory 1332′. In some aspects, the DU 1330 may further include additional memory modules 1334 and a communications interface 1338. The DU 1330 communicates with the RU 1340 through a fronthaul link. The RU 1340 may include an RU processor 1342. The RU processor 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the TA component 199 is configured to transmit, for a UE, an indication of a first TA for a PCell, where the PCell is associated with a first frequency band. The TA component 199 is configured to receive data or at least one signal via a SCell based on a second TA, where the second TA is based on the first TA and a timing offset between the PCell and the SCell, where the SCell is associated with a second frequency band that is greater than the first frequency band. The TA component 199 may be within one or more processors of one or more of the CU 1310, DU 1330, and the RU 1340. The TA component 199 may be one or more hardware components specifically configured to carry out the stated processes/algorithm, implemented by one or more processors configured to perform the stated processes/algorithm, stored within a computer-readable medium for implementation by one or more processors, or some combination thereof. The network entity 1302 may include a variety of components configured for various functions. In one configuration, the network entity 1302 includes means for transmitting, for a UE, an indication of a first TA for a PCell, where the PCell is associated with a first frequency band. In one configuration, the network entity 1302 includes means for receiving data or at least one signal via a SCell based on a second TA, where the second TA is based on the first TA and a timing offset between the PCell and the SCell, where the SCell is associated with a second frequency band that is greater than the first frequency band. In one configuration, the network entity 1302 includes means for receiving, prior to receiving the data or the at least one signal, a request for activating the SCell. In one configuration, the network entity 1302 includes means for transmitting a SSB associated with the SCell. In one configuration, the network entity 1302 includes means for receiving, subsequent to transmitting the SSB associated with the SCell, an acknowledgement that the UE has synchronized with the SCell. In one configuration, the network entity 1302 includes means for configuring, prior to transmitting the indication of the first TA, the first TA for the PCell, where the indication of the first TA is transmitted based on the configuration. The means may be the TA component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means. A wireless communication system may allow for transmission and reception of data over a subTHz frequency band. The subTHz frequency band may allow for faster data rates in comparison to other frequency bands (e.g., FR1, FR2, FR4). However, in comparison to wireless communications systems using non-subTHz frequencies, a wireless communication system that utilizes subTHz frequencies may have limited coverage and/or higher power specifications. A UE within a subTHz deployment may be connected to a PCell associated with FR1/FR2/FR4 and an SCell associated with a subTHz frequency. In order to transmit data/signals over the SCell/subTHz, a UE may obtain a TA. Obtaining a TA via a RACH procedure with the SCell/subTHz may be time consuming and may be associated with increased latency and/or increased power consumption at the UE. Various technologies pertaining to deriving a SCell/subTHz TA based on a PCell TA are described herein. In an example, a UE obtains an indication of a first TA for a PCell, where the PCell is associated with a first frequency band. The UE estimates a timing offset between the PCell and a SCell. The UE derives a second TA for the SCell based on the first TA and the timing offset, where the SCell is associated with a second frequency band that is greater than the first frequency band. The UE transmits, for a network node, data or at least one signal via the SCell based on the second TA. Via derivation of the second TA based on the first TA and the timing offset, the UE may be able to avoid performing a RACH procedure with the SCell/subTHz. Thus, the latency for transmission of data/signals via the SCell/subTHz may be lower in comparison to latency associated with a scenario in which the UE obtains the second TA via a RACH procedure. Furthermore, by avoiding performing the RACH procedure with the SCell/subTHz, the above-described technologies may be associated with lower power consumption by the UE and/or lower computational burdens on the UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented. The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: obtaining an indication of a first TA for a PCell, where the PCell is associated with a first frequency band; estimating a timing offset between the PCell and a SCell; deriving a second TA for the SCell based on the first TA and the timing offset, where the SCell is associated with a second frequency band that is greater than the first frequency band; and transmitting, for a network node, data or at least one signal via the SCell based on the second TA.

Aspect 2 is the method of aspect 1, where the second frequency band is a sub-terahertz (subTHz) frequency band that is frequency range 5 (FR5).

Aspect 3 is the method of any of aspects 1-2, where obtaining the indication of the first TA includes: receiving the indication of the first TA from the network node.

Aspect 4 is the method of any of aspects 1-3, further including: obtaining, prior to estimating the timing offset, a second indication of the timing offset between the PCell and the SCell, where the timing offset is estimated based on the second indication.

Aspect 5 is the method of any of aspects 1-4, where the timing offset between the PCell and the SCell is a downlink timing offset.

Aspect 6 is the method of any of aspects 1-5, where the data or the at least one signal is transmitted via the SCell to one or more repeaters.

Aspect 7 is the method of aspect 6, where each of the one or more repeaters is associated with a respective TA for communication via the SCell.

Aspect 8 is the method of any of aspects 1-7, where the timing offset is valid for a time duration, where the data or the at least one signal is transmitted within the time duration.

Aspect 9 is the method of any of aspects 1-8, where the PCell and the SCell are co-located.

Aspect 10 is the method of any of aspects 1-9, where deriving the second TA for the SCell includes: calculating a difference between the first TA and twice the timing offset.

Aspect 11 is the method of any of aspects 1-10, further including: transmitting, prior to estimating the timing offset, a request for activating the SCell; receiving a synchronization signal block (SSB) associated with the SCell; and synchronizing with the SCell based on the SSB, where the timing offset is estimated based on the SSB.

Aspect 12 is the method of aspect 11, further including: transmitting, subsequent to synchronizing with the SCell, an acknowledgement that synchronization with the SCell has been achieved.

Aspect 13 is the method of any of aspects 11-12, where the SSB associated with the SCell corresponds to a certain repeater in a set of repeaters.

Aspect 14 is the method of any of aspects 1-13, where the UE has a continuous connection to the PCell, and where the UE has a non-continuous connection to the SCell.

Aspect 15 is the method of any of aspects 1-14, where the first frequency band is at least one of: frequency range 1 (FR1), frequency range 2 (FR2), or frequency range 4 (FR4).

Aspect 16 is an apparatus for wireless communication at a user equipment (UE) including a memory and at least one processor coupled to the memory and based at least in part on information stored in the memory, the at least one processor is configured to perform a method in accordance with any of aspects 1-15.

Aspect 17 is an apparatus for wireless communications, including means for performing a method in accordance with any of aspects 1-15.

Aspect 18 is the apparatus of aspect 16 or 17 further including at least one of a transceiver or an antenna coupled to the at least one processor, where the at least one processor is configured to transmit, for the network node, the data or the at least one signal via the SCell based on the second TA via at least one of the transceiver or the antenna.

Aspect 19 is a computer-readable medium (e.g., a non-transitory computer-readable medium) including instructions that, when executed by an apparatus, cause the apparatus to perform a method in accordance with any of aspects 1-15.

Aspect 20 is a method of wireless communication at a network node, including: transmitting, for a UE, an indication of a first TA for a PCell, where the PCell is associated with a first frequency band; and receiving data or at least one signal via a SCell based on a second TA, where the second TA is based on the first TA and a timing offset between the PCell and the SCell, where the SCell is associated with a second frequency band that is greater than the first frequency band.

Aspect 21 is the method of aspect 20, where the second frequency band is a subTHz frequency band that is FR5.

Aspect 22 is the method of any of aspects 20-21, where the timing offset between the PCell and the SCell is a downlink timing offset.

Aspect 23 is the method of any of aspects 20-22, where the data or the at least one signal is received via the SCell from one or more repeaters.

Aspect 24 is the method of any of aspects 20-23, where each of the one or more repeaters is associated with a respective TA for communication via the SCell.

Aspect 25 is the method of aspect 24, where the timing offset is valid for a time duration, where the data or the at least one signal is received within the time duration.

Aspect 26 is the method of any of aspects 20-25, where the PCell and the SCell are co-located.

Aspect 27 is the method of any of aspects 20-26, where the second TA is a difference between the first TA and twice the timing offset.

Aspect 28 is the method of any of aspects 20-27, further including: receiving, prior to receiving the data or the at least one signal, a request for activating the SCell; and transmitting a SSB associated with the SCell.

Aspect 29 is the method of aspect 28, further including: receiving, subsequent to transmitting the SSB associated with the SCell, an acknowledgement that the UE has synchronized with the SCell.

Aspect 30 is the method of any of aspects 20-29, where the network node has a continuous connection with the UE via the PCell, where the network node has a non-continuous connection with the UE via the SCell.

Aspect 31 is the method of any of aspects 20-30, where the first frequency band is at least one of: FR1, FR2, or FR4.

Aspect 32 is the method of any of aspects 20-31, further including: configuring, prior to transmitting the indication of the first TA, the first TA for the PCell, where the indication of the first TA is transmitted based on the configuration.

Aspect 33 is an apparatus for wireless communication at a network node including a memory and at least one processor coupled to the memory and based at least in part on information stored in the memory, the at least one processor is configured to perform a method in accordance with any of aspects 20-32.

Aspect 34 is an apparatus for wireless communications, including means for performing a method in accordance with any of aspects 20-32.

Aspect 35 is the apparatus of aspect 33 or 34 further including at least one of a transceiver or an antenna coupled to the at least one processor, where the at least one processor is configured to transmit, for the UE, the indication of the first TA for the PCell and receive the data or the at least one signal via the SCell based on the second TA via at least one of the transceiver or the antenna.

Aspect 36 is a computer-readable medium (e.g., a non-transitory computer-readable medium) including instructions that, when executed by an apparatus, cause the apparatus to perform a method in accordance with any of aspects 20-32.

1. An apparatus for wireless communication at a user equipment (UE), comprising:
a memory; and
at least one processor coupled to the memory and, based at least in part on information stored in the memory, the at least one processor is configured to:
obtain an indication of a first timing advance (TA) for a primary cell (PCell), wherein the PCell is associated with a first frequency band;
estimate a timing offset between the PCell and a secondary cell (SCell);
derive a second TA for the SCell based on the first TA and the timing offset, wherein the SCell is associated with a second frequency band that is greater than the first frequency band; and
transmit, for a network node, data or at least one signal via the SCell based on the second TA.

2. The apparatus of claim 1, wherein the second frequency band is a sub-terahertz (subTHz) frequency band that is frequency range 5 (FR5).

3. The apparatus of claim 1, wherein to obtain the indication of the first TA, the at least one processor is configured to:
receive the indication of the first TA from the network node.

4. The apparatus of claim 1, wherein the at least one processor is further configured to:
obtain, prior to the timing offset being estimated, a second indication of the timing offset between the PCell and the SCell, wherein the timing offset is estimated based on the second indication.

5. The apparatus of claim 1, wherein the timing offset between the PCell and the SCell is a downlink timing offset.

6. The apparatus of claim 1, wherein the data or the at least one signal is transmitted via the SCell to one or more repeaters.

7. The apparatus of claim 6, wherein each of the one or more repeaters is associated with a respective TA for communication via the SCell.

8. The apparatus of claim 1, wherein the timing offset is valid for a time duration, wherein the data or the at least one signal is transmitted within the time duration.

9. The apparatus of claim 1, wherein the PCell and the SCell are co-located.

10. The apparatus of claim 1, wherein to derive the second TA for the SCell, the at least one processor is configured to:
calculate a difference between the first TA and twice the timing offset.

11. The apparatus of claim 1, wherein the at least one processor is further configured to:
transmit, prior to the timing offset being estimated, a request for an activation of the SCell;
receive a synchronization signal block (SSB) associated with the SCell; and
synchronize with the SCell based on the SSB, wherein the timing offset is estimated based on the SSB.

12. The apparatus of claim 11, wherein the at least one processor is further configured to:
transmit, subsequent to the SCell being synchronized with, an acknowledgement that synchronization with the SCell has been achieved.

13. The apparatus of claim 11, wherein the SSB associated with the SCell corresponds to a certain repeater in a set of repeaters.

14. The apparatus of claim 1, wherein the UE has a continuous connection to the PCell, and wherein the UE has a non-continuous connection to the SCell.

15. The apparatus of claim 1, wherein the first frequency band is at least one of: frequency range 1 (FR1), frequency range 2 (FR2), or frequency range 4 (FR4).

16. The apparatus of claim 1, further comprising at least one of a transceiver or an antenna coupled to the at least one processor, wherein the at least one processor is configured to transmit, for the network node, the data or the at least one signal via the SCell based on the second TA via at least one of the transceiver or the antenna.

17. A method of wireless communication at a user equipment (UE), comprising:
obtaining an indication of a first timing advance (TA) for a primary cell (PCell), wherein the PCell is associated with a first frequency band;
estimating a timing offset between the PCell and a secondary cell (SCell);
deriving a second TA for the SCell based on the first TA and the timing offset, wherein the SCell is associated with a second frequency band that is greater than the first frequency band; and
transmitting, for a network node, data or at least one signal via the SCell based on the second TA.

18. An apparatus for wireless communication at a network node, comprising:
a memory; and
at least one processor coupled to the memory and, based at least in part on information stored in the memory, the at least one processor is configured to:
transmit, for a user equipment (UE), an indication of a first timing advance (TA) for a primary cell (PCell), wherein the PCell is associated with a first frequency band; and
receive data or at least one signal via a secondary cell (SCell) based on a second TA, wherein the second TA is based on the first TA and a timing offset between the PCell and the SCell, wherein the SCell is associated with a second frequency band that is greater than the first frequency band.

19-20. (canceled)

21. The apparatus of claim 18, wherein the data or the at least one signal is received via the SCell from one or more repeaters.

22. The apparatus of claim 21, wherein each of the one or more repeaters is associated with a respective TA for communication via the SCell.

23-30. (canceled)
